(19) United States
(12) Patent Application Publication
(10) Pub. No.: US 2024/0098221 A1
(43) Pub. Date: Mar. 21, 2024

(54) METHOD AND APPARATUS FOR DELIVERING VIDEO AND VIDEO-RELATED CONTENT AT SUB-ASSET LEVEL

(71) Applicant: Comcast Cable Communications, LLC, Philadelphia, PA (US)

(72) Inventors: Morgan R. Hays, Swarthmore, PA (US); Randall Hounsell, Glen Mills, VA (US); Jeanine Heck, Wynnewood, PA (US)

(21) Appl. No.: 18/487,675

(22) Filed: Oct. 16, 2023

Related U.S. Application Data
(63) Continuation of application No. 12/274,452, filed on Nov. 20, 2008, now Pat. No. 11,832,024.

(51) Int. Cl. H04N 7/173; H04N 21/442; H04N 21/482; H04N 21/845

(52) U.S. Cl. CPC H04N 7/17318; H04N 21/44204; H04N 21/4826; H04N 21/4828; H04N 21/8456

(57) ABSTRACT

A method and apparatus for delivering an ordered list of items of supplemental content to a consumer comprising determining a context of a portion of media selected for consumption, determining consumer preference information corresponding to the consumer, generating the ordered list of items of supplemental content as a function of the context and of the consumer preference information.

### FIELD OF THE INVENTION

The invention pertains to the delivery to consumers of personalized video and video-related content at the sub-asset level. More particularly, the invention pertains to search and discovery software that can, for example, be embodied within a set-top box, Internet browser, intelligent television, intelligent radio, or the like.

### BACKGROUND OF THE INVENTION

The current paradigm for delivery of audio and video services, radio services and Internet services to consumers, be it over-the-air broadcasts, cable television service, Internet television service, telephone network television service, satellite television service, satellite radio service, websites, etc., delivers a relatively unpersonalized, generic experience to all viewers. That is, for example, all of the subscribers of a given television network system receive essentially the same content in essentially the same order.

Cable and satellite television services and websites permit some personalization in that many such television network systems permit each individual viewer to access and download Video-on-Demand content. The Video-on-Demand feature (VOD) may be considered to comprise personalization in some sense because it allows a viewer to select content for viewing at any time of his or her choice that is different from content being provided to other subscribers. However, the typical VOD feature provided by television network operators is generic in the sense that the VOD options (e.g., the programs available for viewing on demand) are the same for all subscribers and are presented in the same manner to all subscribers. Furthermore, the items available for consumption via the VOD feature are complete assets. For instance, a subscriber using the VOD feature is enabled to select and download and view an entire asset, such as a television program, a music video, movie, instructional video, etc., but not a particular portion thereof.

United States Patent Application Publication No. 2008/0133504 discloses a method and apparatus for contextual search query refinement on consumer electronics devices. In the disclosed method and apparatus, a consumer electronics apparatus, such as a television, is enabled to search the Internet for content, the search being performed and refined based on contextual information, such as the consumer electronic device's current activity, e.g., playing a music CD or playing a DVD, and the actual content of the media. While the method and apparatus disclosed in that patent application provides additional content for potential viewing by a subscriber, there is no customization or personalization of the content in that each subscriber will receive the same search results for a search performed in a particular context (e.g., the particular song playing on a particular CD). The specific search results depend solely on the particular context of the media, and not anything particular to the specific subscriber.

### SUMMARY OF THE INVENTION

The invention pertains to a method and apparatus for delivering an ordered list of items of supplemental content to a consumer comprising determining a context of a portion of media selected for consumption, determining user preference information corresponding to the consumer, and generating the ordered list of items of supplemental content as a function of the context and of the consumer preference information.

### BRIEF DESCRIPTION OF THE DRAWINGS

FIG. 1 is a block diagram of the components of an exemplary cable television network system that supports features in accordance with the present invention.

FIG. 2 is an exemplary interface screens that can be used in connection with the present invention.

FIG. 3 is a flow diagram illustrating flow according to one exemplary process for generating search results for presentation to a viewer in accordance with the principles of the present invention.

### DETAILED DESCRIPTION OF THE INVENTION

The present invention pertains to methods and apparatus for automatically presenting to a consumer of a media asset a customized set of optional media content, the optional media content being automatically selected and presented to the consumer as a function of the media asset currently being consumed and the predicted personal preferences of the consumer himself or herself.

In one particular embodiment in connection with which the invention will first be described for exemplary purposes, the invention is presented in the context of a television network system, such as cable television. However, it should be understood that this embodiment is merely exemplary and that the principles of the present invention can be applied in other information networks, including the Internet, and satellite radio networks.

“Information network” refers to a collection of devices having a transport mechanism for exchanging information or content between the devices. Such networks may have any suitable architecture, including, for example, client-server, 3-tier architecture, N-tier architecture, distributed objects, loose coupling, or tight coupling.

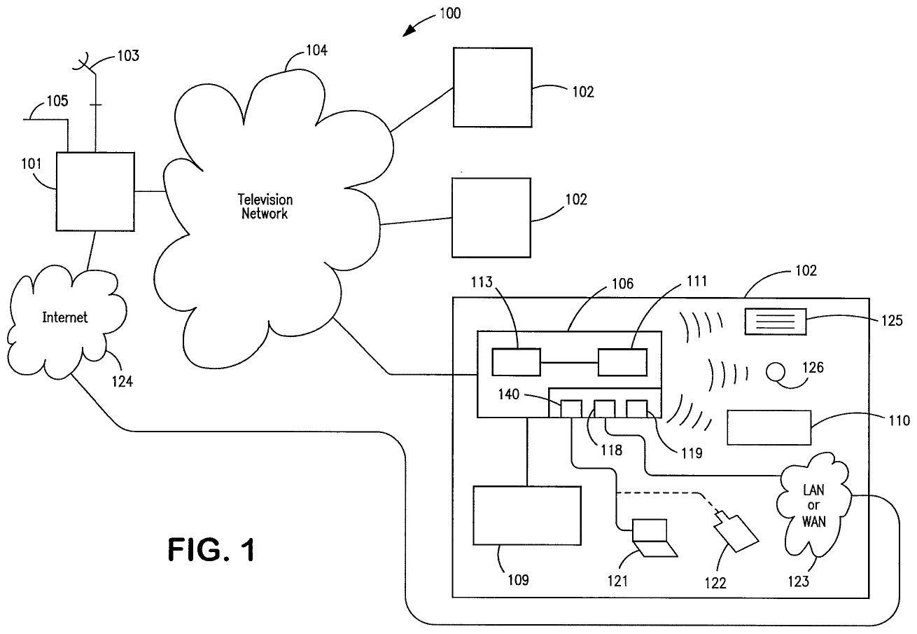

FIG. 1 is a block diagram illustrating a set of components found in a cable television system 100 in which the present invention can be incorporated. Cable network system 100 includes a server, such as a headend 101, that receives content that is to be transmitted to the subscriber locations 102 of the cable network system.

The term “transmitted” or “transmits” refers broadly to sending a signal from a transmitting device to a receiving device. The signal may be transmitted wirelessly or over a solid medium such as wire or fiber. Furthermore, the signal may be broadcast, multicast/narrowcast, or unicast. Broadcasting refers to the transmission of content to an audience at large. The audience may be the general public, or a sub-audience. Switched digital video is a type of broadcast that is initiated in response to a client request and is terminated when no more clients are tuned to it. Multicasting refers to the simultaneous transmission of content to a plurality of specific and known destinations or addresses in a network or between networks. Multicast is often used for streaming media and Internet television applications, Ethernet multicast addressing, ATM point-to-multipoint VCs and Infiniband® multicast. Unicasting refers to the transmission of a signal to a single destination or address in a network. Unicast is used, for example, in Video-On-Demand applications.

The headend 101 receives the content to be broadcast from one or more sources, for example, such as a satellite 103 or a landline 105. The data is modulated at the headend 101 for distribution over the medium of the network 104, e.g., coaxial cable, optical fiber, wireless satellite communication, etc., to the subscriber locations 102 in their individual homes, businesses, cars, etc. One particular exemplary subscriber location 102 is shown in detail in FIG. 1. Typically, each subscriber will have a client device, such as a radio receiver, computer terminal, or set top box 106, in communication with the server through the network 104.

“Set top box” or STB refers to a device that connects to a monitor and an external source of signal, converting the signal into content for display/transmission over the monitor. The signal source might be an Ethernet cable, a satellite dish, a coaxial cable, a fiber optic cable, a telephone line (including DSL connections), Broadband over Power Line, or even an ordinary antenna. The STB may have several different embodiments. For example, it may be a special digital STB for delivering digital content on TV sets that do not have a built in digital tuner. The STB may also descramble premium channels. A STB may be a cable converter box to receive digital cable TV channels and convert them to analog for non-digital TVs. In the case of direct broadcast satellite (mini-dish) systems such as SES Astra®, Dish Network®, or DirecTV®, the STB is an integrated receiver/decoder (or IRD). In internet packet (IP) TV networks, the STB is a small computer providing two-way communications on an IP network, and decoding the video streaming media which eliminates the need for any coaxial cabling. The STB may be a discrete unit or its functionality may be incorporated into other components of the user's system such as the monitor, TV, DVR, residential gateway, or personal computer. For example, the STB may be a portable, modular unit (i.e., a personal STB) or it may be integrated into a stationary TV system. The STB may contain one or more digital processors or may use the processing capabilities of the other system components (e.g., TV, DVR, personal computer). Additionally, rather than having its own tuner, the STB may use the tuner of a television.

A set top box 106 commonly will be′ connected to provide its output to a monitor 109, such as a television set. Commonly, a handheld remote control unit 110 communicates wirelessly (e.g., infrared) with the set top box 106 to control functions and operations of the set top box 106.

The set top box 106 is capable of receiving the content signals, permitting the user to select a particular channel for viewing, and demodulating the content on that channel to a form that can be displayed on the subscriber's television or other monitor 109. The STB further may control access to various channels and other content, such as on demand, pay-per-view programs, premium channels, etc., based on permissions granted to each individual subscriber based on their subscription plan, parental controls, and other criteria.

The set top box 106 can, not only receive data from the headend 101 through the network 104, but also transmit data upstream to the headend 101. For instance, set top boxes commonly transmit data upstream for purposes of ordering VOD or pay-per-view content.

The set top box 106 includes a processor 113 for running software to provide various functions. Preferably, it further includes a memory storage device, such as a hard disk drive 111, for recording television, programs and/or other content. Set top boxes with this recording capability are commonly referred to as digital video recorder (DVR) set top boxes (STBs) or DVR-STBs. They provide the user the ability to search through upcoming television programming and selectively designate certain programs of the user's choosing to be recorded. The set top box 106 is programmed to provide various graphical user interfaces (GUIs), such as in the form of menus, permitting the user to interact (typically using the remote control unit 110) with the set top box 106 and/or the headend 101.

The set top box 106 may further include an input terminal 118 for connecting to a LAN or WAN 123 (preferably with connectivity to the Internet 124). Alternately or additionally, connectivity to the Internet 124 may be provided through the television network 104 itself via the headend 101.

The set top box 106 may be configured with Internet browser software and software for permitting users to interface with the Internet browser software, such as through a keyboard 125 and/or mouse 126.

In accordance with the present invention, a user of an information network (any system through which a user can access information), is offered supplemental content, the supplemental content being selected and/or organized as a function of both the user's personal preferences and the information currently being consumed by the user (i.e., the context). Furthermore, in a preferred embodiment of the invention, the supplemental content is offered on a sub-asset level. That is, the supplemental content is provided in units that may be smaller than the units in which that type of information conventionally is offered for consumption. Media items are typically offered by programmers and network operators in generally predefined portions herein termed assets. For instance television programs such as dramas, soap operas, reality shows, and sitcoms are typically broadcast in asset level units known as episodes that commonly are a half hour or an hour in length (including advertisements). Sporting events are broadcast in asset units of a single game. Music videos are commonly offered in asset units corresponding to a complete song or a complete concert performance.

The definition of the term “asset” is well understood in the industry as well as among content consumers. For instance, a typical programming guide printed in a newspaper or the electronic program guides commonly provided by a subscriber-based television network are well known to virtually all television viewers and generally list multimedia content at the asset level.

In any event, a media asset typically can conceptually be broken down into a plurality of segments at the sub-asset level, each having a cohesive context or theme. “Context” or “contextual information” refers broadly to the subject matter or theme of the content and can be virtually anything within the realm of human knowledge, such as baseball, strike out, fast ball, stolen base, mountains, scary, happy, George Carlin, nighttime. The nature and duration of each segment will depend, of course, on the particular ontology used for purposes of segmentation as well as on the particular content of each program. “Content” refers broadly to the information contained in the signal transmitted, and includes, for example, entertainment, news, and commercials. For instance, most stage plays, and motion pictures readily break down into two or three acts. Each such act can be a different segment. Television programs also can be segmented according to thematic elements. Certain programs, for instance, the television news magazine program 60 Minutes can readily be segmented into different news stories. Other programs, however, can be segmented based on more subtle thematic elements. A baseball game can be segmented by inning, for instance. A typical James Bond movie can be segmented into a plurality of action segments, a plurality of dramatic segments, and a plurality romantic segments. The possibilities for segmentation based on thematic elements is virtually limitless and these are only the simplest of examples.

In accordance with the present invention as will be described in more detail below, information is offered in segments smaller than asset level units. For example, supplemental content may be offered in the form of individual coherent scenes from a television program or motion picture, a portion of a music video, a particular news report within a news program, a coherent portion of a Web page, the chorus portion of a song, etc.

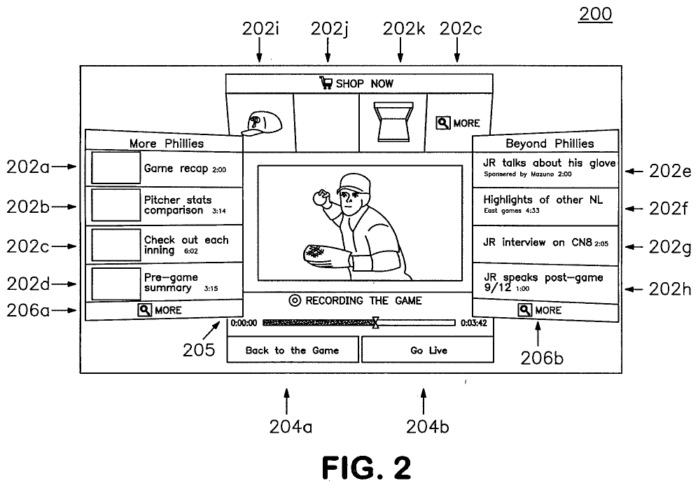

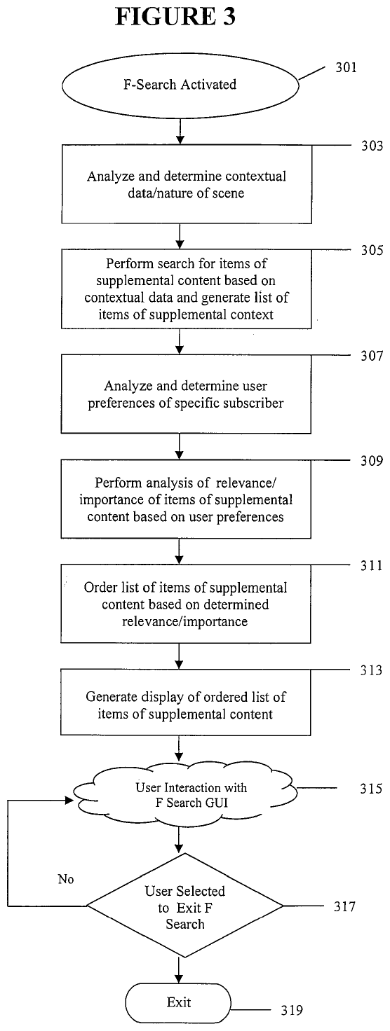

The invention is perhaps best described initially by way of an example. Accordingly, an exemplary embodiment of the invention as implemented in connection with a television network (cable, satellite, Internet, telephone, fiber optic, etc.) will be described herein below in connection with FIGS. 2 and 3.

Let us consider an individual consumer who is watching a particular television program, in this example, a major league baseball game between the Philadelphia Phillies and the New York Mets. In accordance with this particular exemplary embodiment, the consumer is permitted at any time during the program to activate a supplemental content search feature (hereinafter F-Search). Activation of this feature may be provided through any reasonable means, such as a dedicated button on a remote control unit or portable consumer device (e.g., a smart phone, a media player, etc.) or a hyperlink in a Web browser. When the feature is thus selected, the local device, for instance, sends a signal upstream to a server requesting invocation of the F-Search feature. In response, the server performs a search for supplemental content that pertains to the context of the particular content being consumed by that consumer at that time. Furthermore, in a preferred embodiment, the supplemental content is organized for presentation to the consumer in a manner that is a function of user preferences. For instance, the results may be ordered from highest to lowest relevance or importance as a function of the user preferences. The content may not only be ordered at least partially as a function of user preferences, but may be actually selected for inclusion in the list of supplemental content as a function of user preferences.

Even further, the supplemental content offered to the user may comprise at least some media items at the sub-asset level. Supplemental content offered at the sub-asset level may include content from both the current context, i.e., the Philadelphia Phillies vs. New York Mets game currently being watched, as well as sub-asset level content from media items not currently being consumed by the user.

The exact form in which the items of supplemental content are presented to the user can be any reasonable form. FIG. 2 shows one particular possible interface in the form of a graphical user interface (GUI) 200 that the user can interact with very simply via the use of one or more navigation buttons (e.g., UP, DOWN, LEFT, and/or RIGHT buttons) and a SELECT button. In this particular example, the program that the consumer was originally watching is paused, but remains on the display in a small window 201 in the center of the display and surrounded by a plurality of icons, each representing either an individual item of supplemental media content or a list of items of supplemental content. In this example, each icon comprises a button 202a-202k that the user may select by navigating to it and selecting it. In other embodiments, the media originally being consumed may disappear from the screen and/or the item of supplemental content may be shown in a numbered list from which the user can select an item by entering its number on the remote-control unit.

In a preferred embodiment of the invention, only a limited number of media items deemed to be the most relevant items of supplemental content are presented on the display at any given time. In this example, the results are broken down into three categories. However, this is merely exemplary and the media items of supplemental content can be in a single or any other number of lists. First, on the left-hand side of the main window 201, a list of four items 202a, 202b, 202c, 202d of supplemental content pertaining to one or both of the teams playing the game is provided. Second, on the right-hand side of the main window, a list of four items 202e, 202f, 202g, 202h of supplemental content relevant to the program and scene, but not specifically related to the teams is presented. Third, above of the main window 201, the subscriber is presented with three more items 202i, 202j, 202k of supplemental content pertaining to the purchase of merchandise and the like. In this case, the subscriber is presented with the opportunity to buy goods and/or services deemed relevant to the program being viewed. In this example, item 202i allows the subscriber to purchase Philadelphia Phillies baseball caps. Item 202j allows the subscriber to purchase Philadelphia Phillies Jackets. Finally, item 202k allows the subscriber to order pizza delivery online.

The supplemental content on both the left hand and right hand sides of the picture are ordered according to the determined user preferences.

In addition, beneath the main window, is a time bar 205 that shows the point at which the game was paused relative to the current real-time of the game broadcast. Beneath that are two more options. The first one 204a allows the consumer to exit out of the F-Search GUI and return to the program being viewed starting from the point at which the program was paused. The other option 204b exits the F-Search feature and returns the consumer to the program at the current real-time point in the game broadcast.

In addition, for each of the three categories into which the supplemental content items is organized in this particular embodiment, there is a MORE button 206a, 206b, 206c. The selection of one of the MORE buttons causes the next most relevant items of supplemental content in that particular category to appear on the screen in the place previously occupied by the preceding list of first most relevant items. In a preferred embodiment, the user is permitted to click on each MORE button multiple times to continue to view additional items of supplemental content of lesser and lesser relevance.

As previously noted, the search engine selects and organizes items of supplemental content as a function of both (1) the context in which the F-Search feature was invoked (i.e., the particular program and scene being viewed) and (2) predetermined user preferences. For instance, as previously mentioned, let us assume that the program being viewed is a baseball game between the Philadelphia Phillies and the New York Mets and the particular scene during which F-Search was invoked was immediately after Philadelphia Phillies shortstop Jimmie Rollins made a spectacular catch to rob New York Mets batter Marlon Anderson of a base hit. Accordingly, relevant supplemental content may include, for instance, a recorded interview with Jimmie Rollins, a recorded interview with Marlon Anderson, a highlight reel of great plays by Jimmie Rollins, a highlight reel of great hits by Marlon Anderson, New York Mets season statistics, Philadelphia Phillies season statistics, career statistics for Jimmie Rollins, career statistics for Marlon Anderson, the current team standings, results of other baseball games being played that day, etc.

The relevance of each of these items of supplemental content to the viewer may be highly dependent on the particular viewer. For instance, a fan of the Philadelphia Phillies probably would probably deem the highlight clips of Marlon Anderson or the career statistics of Marlon Anderson as possessing low relevance. Conversely, a Mets fan viewing the same game and scene would deem these same pieces of content as highly relevant.

Thus, the F-Search feature not only automatically detects the context in which the F-Search feature was invoked, and uses the contextual information to search for supplemental contents, but also utilizes a prediction as to the particular viewer's preferences in selecting supplemental content and/or ordering the items of supplemental content. In one embodiment of the invention, the list or lists of items of supplemental content is determined as a function of the context without consideration of user preferences and then those items are ordered for presentation in terms of relevance as a function of user preferences. However, in other embodiments, the selection of items for inclusion in the list itself can be a function of both context and user preferences.

Context can be determined in an automated fashion through the use of one or more of several technologies. Of course, it is possible to do this by human effort, i.e., a person watches media assets and manually takes note of coherent segments and their thematic elements and then enters the information in a database. However, with the sheer volume of media content available today and which is only likely to increase exponentially in the future, at least some automation of the process would be highly desirable.

Many software systems are available now that can be adapted for use in connection with this task. For instance, software is now available that can capture the closed caption stream within a media asset and convert it to written text, which could then be analyzed for context. Further, software is available that can analyze the audio portion of a media stream and convert speech detected in the audio text (which can then further be analyzed for context). In fact, software is now available that can analyze the audio portion of a media stream to determine additional contextual information from sounds other than speech. For instance, such software can detect, recognize and distinguish between, for instance, the sound of a crowd cheering or a crowd booing, sounds associated with being outdoors in a natural setting or being outdoors in an urban setting or being indoors in a factory or an office or a residence, etc. For example, U.S. Pat. No. 7,177,861 discloses suitable software for detecting semantic events in an audio stream.

Even further, optical character recognition software can be used to determine text that appears in a scene (as opposed to being audibly spoken). See, e.g. Li, Y. et al. “Reliable Video Clock Recognition,” Pattern Recognition, 2006, 1CPR 2006, 18^{th} International Conference on Pattern Recognition. Such software can be used, for instance, to detect the clock in a timed sporting vent. Specifically, knowledge of the game time could be useful in helping determine the nature of a scene. For instance, whether the clock is running or not could be informative as to whether the ball is in play or not during a football game. Furthermore, certain times during a sporting event are particularly important, such as two minutes before the end of a professional football game. Likewise, optical character recognition can be used to determine the names of the actors or other significant persons in a television program or the like simply by reading the credits at the beginning or end of the program.

Furthermore, video analytics software is available that can analyze the visual content of a media stream to determine context, e.g., indoors or outdoors, presence or absence of cars and other vehicles, presence or absence of human beings, presence or absence of non-human animals, etc. In fact, software is available today that can be used to actually recognize specific individuals by analyzing their faces.

Even further, there may be significant metadata contained in a media stream. While some may consider the closed captioning stream to be metadata, we here refer to additional information. Particularly, the makers or distributors of television programs or third party providers sometimes insert metadata into the stream that might be useful in determining the context of an asset or of a segment within an asset. Such metadata may include almost any relevant information, such as actors in a scene, timestamps identifying the beginnings and ends of various segments within a program, the names of the teams in a sporting event, the date and time that the sports event actually occurred, the number of the game within a complete season, etc. Accordingly, the system may also include software for analyzing such metadata.

Even further, companies now exist that provide the services of generating and selling data about television programs and other media assets. For instance, Stats, Inc. of Northbrook, IL, USA sells such metadata about sporting events. Thus, taking a baseball game as an example, the data may include, for instance, the time that each half inning commenced and ended, data for each at bat during the game, such as the identity of the batter, the times at which the at-bat commenced and ended, the statistics of each player in the game, the score of the game at any given instance, the teams playing the game, etc.

User preferences likewise can be determined from various sources of information readily available to website operators, radio network operators, television network, etc. For instance, this may include the geographic location of the user, information about the user's household members (such as ages, professions, personal interests), that may have been obtained from a user directly when the user subscribed to the service (or that can be obtained through third-party services that provide such data for a fee). Other sources of data include demographic data about the geographic area in which a user lives.

Perhaps most significantly, user preference data can be obtained from the user's media consumption habits, (subject to the user's consent to collect such data). Particularly, a media service provider, such as a cable television network or website, may record and maintain records of (1) all linear programs consumed by a media consumer, (2) programs viewed via VOD, (3) the specific subscription plan purchased by the consumer (if it is a subscription-based service), (4) the programs the consumer recorded on his or her DVR-STB or computer, (5) how often particular programs have been consumed (either linearly or through use of a DVR-STB or other recording device or software), (6) how often particular scenes within a program are consumed by the consumer, and (7) the consumer's past consumption of supplemental content via usage of the F-Search feature (particularly, the specific items of supplemental content selected from the search results presented). The term “linear” above or “linear consumption” refers to how a person consumes (e.g., watches) television programs in real time as they are being broadcast by a content provider.

Merely as an example, a user living in Philadelphia that has watched every Philadelphia Phillies game broadcast since subscribing to the television service and that has ordered VOD programs pertaining to the Philadelphia Phillies, and for whom a large portion of his or her television consumption comprises sporting events involving Philadelphia area teams, and who has never watched a New York Mets game (except for when the New York Mets are playing the Philadelphia Phillies) can easily be predicted to be more interested in a highlight reel pertaining to Jimmie Rollins than a highlight reel pertaining to Marlon Anderson.

The prediction of relevance of any item of supplemental content as a function of user preferences can be performed using a multi-variable regression equation having as its input data the aforementioned variables such as linear television consumption, VOD television consumption, geographic data, demographic data, etc., the particular variables. The weighting coefficient applied to each variable, and the specific equation (e.g., least mean squares) would all depend on the particular available information, experimentation with different variables. The variable, the weighting factors, the equations, and other factors can be modified and updated periodically based on historical performance and even possibly user satisfaction surveys.

The selection of the items of supplemental content based on context also may be performed using any reasonable multi-variable regression equation having as its inputs, for example, any one or more of the aforementioned variables, such as the closed-captioning stream, the video analytics output stream, the audio analytics output stream, the metadata associated with the program, etc.

The equipment for providing functionality in accordance with the invention may reside at any reasonable location in the network, such as at a headend or server, at a content management center, or even at the set top box, Web browser, radio receiver, or other device local to the consumer. The most likely embodiments of the invention will comprise software programs running on digital processing devices such as computers, microprocessors, digital processors, etc. However, at least parts of the functionalities set forth herein could also be complemented by other means such as ASICs (Application Specific Integrated Circuits), FPGAs (Field Programmable Gate Arrays), state machines, combinational logic circuits, analog circuits, human operator, and any combination of the above.

The software and/or other circuits may be distributed among different nodes of a network, such as a server and a client node. Also, the software may be embodied in any form of memory that can be associated with a digital processing apparatus, including, but not limited to RAM, ROM, PROM, EPROM, EEPROM, DRAM, Compact Disc, Tape, Floppy Disc, DVD, SD memory devices, Compact Flash memory devices, USB memory devices, etc.

In some embodiments, some or all of the items of supplemental content can be pre-determined. That is, for instance; even in a broadcast of a live event, such as a broadcast of a live baseball game, some items of supplemental content can be preset, such as the season records of the two teams that are known to be playing the game. Other items of supplemental content can be found (or even generated) in real time in response to the particular context. Generating and/or finding items of supplemental content in real time based on contextual information can be accomplished easily. Particularly, once the context is determined, the generation of the items of supplemental content can be generated via a search on the Internet similar to the searches performed by any Internet search engine. The context determination can be performed and formulated into a search query in a fraction of a second and the search for items of supplemental content based on that query also can be performed in a fraction of a second. Finally, the list of items of supplemental content can be run through a regression analysis that will order the items in a selected order within a fraction of a second. The entire process can readily be performed in substantially less than a second.

In other systems, most or all of the items of supplemental content can be predetermined. For instance, when viewing a motion picture (as opposed to a live performance or event), the content of the motion picture may be analyzed ahead of time and some or all of the supplemental content to be made available at any given instant in the motion picture can be pre-determined. For instance, it is widely known that the Star Wars series of movies contains many light saber fight scenes and that many fans of the series are particularly interested in the light saber fight scenes. Accordingly, the individual light saber scenes from the various movies in the series may be pre-ordained as items of supplemental content when the F-Search feature is activated during the viewing of any particular light saber fight scene within a Star Wars movie. In one embodiment of the invention, each scene can be contained in the list of supplemental content items as a separate item. However, in another embodiment, one of the items of supplemental content may be, for instance, “See other light saber fight scenes.” If the user chooses that item, the user may be taken to a new menu from which the user can select from a list of light saber fight scenes.

As previously mentioned and as illustrated in the immediately preceding example, items of supplemental content can be provided at the sub-asset level, e.g., light saber fight scene, as opposed to the asset level, e.g., an entire Star Wars movie.

The same basic software used to determine the context of a scene being consumed can likewise be used in software that analyzes media assets and breaks them down into contextually coherent segments at the sub-asset level. More particularly, as an example, the same software that determines that a particular scene being consumed is a light saber fight scene (such as based on sound effects, motion progression in the scene, and meta data associated with the program and/or scene) can readily be applied in the process of identifying the light saber fight scenes within a Star Wars movie for purposes of segmenting a media asset into contextually coherent sub-asset level media segments, including determining the beginning and the end of the light saber fight scene in order to create a coherent sub-asset.

In the particular above-described embodiment, the process of generating the ordered list of items of supplemental content is broken into two separate and distinct steps, namely, generation of the list of search results as a function of context and then ordering of the list as a function of predicted user preferences. However, as previously mentioned, this is merely exemplary. The generation and ordering of the list can be performed together as a function of both context and predicted user preferences.

In one preferred embodiment of the invention, the F-Search feature is available at any time during the consumption of any media asset. Search results can be generated at least partially in real time based on analyzed context and analyzed user preferences. However, the media provider also may pre-identify particular portions of particular media assets as being particularly suitable for supplemental content and, as previously mentioned, may have pre-generated supplemental content particularly relating to such scenes. Thus, in accordance with one preferred embodiment of the invention, a cable television network operator may insert a F-Search icon into the display during such scenes that, in essence, alerts the user to the availability of particularly interesting supplemental content and/or invites the user to activate the F-Search feature.

In some embodiments of the invention, the media being consumed continues to stream during use of the F-Search feature. However, the user can choose to pause the program while using the F-Search feature. In other embodiments, the media may be automatically paused upon activation of the feature. The user may be given the option of continuing to view the original asset.

The invention preferably is implemented primarily or exclusively by software (including appropriate databases) running on a server at a content center, head end, or any other content node of the network. However, portions or all of the functions in accordance with the principles of the invention can be implemented via software and/or hardware and may comprise any one or more of a microprocessor, a processor, combinational logic, a state machine, analog circuitry, digital circuitry, an Application Specific Integrated Circuit (ASIC), a Programmable Logic Array (PLA), any other conventional computing apparatus and/or combinations of any of the above. In other embodiments, the invention may be implemented at the user nodes, such as a set top box or intelligent television.

FIG. 3 is a flow diagram illustrating process flow in accordance with one particular exemplary embodiment of the invention. At step 301, process is commenced responsive to the user activating the F-Search feature. Next, in step 303, software performs an analysis to determine context, e.g., the nature of the scene currently being displayed. As previously mentioned, this may include a regression analysis of the available data about the scene. Such data may include metadata contained in the stream, analysis of the closed captioning stream, video analytics, and/or audio analytics. Next in step 305, a search is performed for items of supplemental content as a function of the determined contextual data and a list is generated of items of supplemental content. Next, in step 307, user preferences are determined for the specific user. As previously mentioned, this also can be performed by a regression analysis based on any or all of the available data about the user, including, for instance, user-provided data such as address, income level, age, gender, demographic data, and viewing habit data collected by the network operator.

In step 309, the system performs an analysis of the importance of the items of supplemental content that were generated in step 305 based on these determined user preferences. In step 311, that list is ordered as a function of the determine relevance/importance. Next, in step 313, the system generates a display with a suitable GUI showing the ordered list of items of supplemental content.

At this point, the user can now interact with the list of supplemental content to select items for viewing, pause the original program, etc. The flow diagram shows this interaction generally at step 315, the details of which can take any number of forms, many of which will be readily apparent to those persons of skill in the related arts and therefore are not shown in detail. Some of the items of supplemental content may be ordered in a menu tree. For instance, selection of a particular item in the GUI generated in step 313 may actually lead to a sub-list of items of supplemental content.

In any event, the user can interact with the GUI as much as desired, and when the user selects to exit the feature (step 317), flow proceeds to step 319 where the process is exited.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A computing device comprising:
one or more processors; and
memory storing instructions that, when executed by the one or more processors, configure the computing device to:
determine a current portion of a content item being output for display;
determine, based on the current portion, a plurality of supplemental content assets;
determine, based on a viewing history of a user or content recorded by a digital video recorder, an order of the plurality of supplemental content assets; and
cause output of a user interface comprising a listing, based on the order, of the plurality of supplemental content assets.

2. The computing device of claim 1, wherein the instructions, when executed, configure the computing device to determine, based on receiving an indication of a user-activation of a supplemental content search function, the current portion of the content item being output for display.

3. The computing device of claim 1, wherein the instructions, when executed, configure the computing device to determine the order of the plurality of supplemental content assets by performing a regression analysis based on whether the content item was recorded by the digital video recorder, whether a portion of the content item was output for display at least once from the digital video recorder, and whether second content was output for display during a broadcast of the second content.

4. The computing device of claim 1, wherein the instructions, when executed, configure the computing device to:
determine the order of the plurality of supplemental content assets by performing a regression analysis based on whether the content item was recorded by the digital video recorder, whether a portion of the content item was output for display at least once from the digital video recorder, and whether second content was output for display during a broadcast of the second content;
perform the regression analysis by applying a first weight to first data indicating whether the content item was recorded by the digital video recorder, applying a second weight to second data indicating whether the portion of the content item was output for display at least once from the digital video recorder, and applying a third weight to third data indicating whether the second content was output for display during the broadcast of the second content; and
adjust the first weight or the second weight based on a survey taken by a user associated with the digital video recorder.

5. The computing device of claim 1, wherein the instructions, when executed, configure the computing device to determine the plurality of supplemental content assets by:
searching, based on the current portion, for the plurality of supplemental content assets; and
generating the listing of the plurality of supplemental content assets by determining, based on data indicating whether the content item was output for display at least once from the digital video recorder, that each of the plurality of supplemental content assets is to be included in the listing.

6. The computing device of claim 1, wherein each of the plurality of supplemental content assets comprises a segment of a television program.

7. The computing device of claim 1, wherein the instructions, when executed, configure the computing device to determine the order of the plurality of supplemental content assets based on one or more of: video analytics data of the current portion, or audio analytics data of the current portion.

8. The computing device of claim 1, the instructions, when executed, configure the computing device to:
insert, into a data stream that comprises the content, metadata associated with the current portion; and
determine, based on the metadata, data associated with the current portion,
wherein the instructions, when executed, configure the computing device to determine the plurality of supplemental content assets based on the data.

9. The computing device of claim 1, wherein the instructions, when executed, configure the computing device to determine the plurality of supplemental content assets based on a request for supplemental content, and wherein the user interface indicates a response to the request for supplemental content.

10. The computing device of claim 1, wherein the instructions, when executed, configure the computing device to:
determine the current portion based on receiving a request for supplemental content; and
determine the plurality of supplemental content assets by:
performing, using data associated with the current portion, a search for the plurality of supplemental content assets.

11. The computing device of claim 1, wherein the instructions, when executed, configure the computing device to:
determine the current portion based on receiving a request for supplemental content; and
determine the plurality of supplemental content assets by:
performing, using data associated with the current portion, a search for the plurality of supplemental content assets via the World Wide Web.

12. The computing device of claim 1, wherein the instructions, when executed, configure the computing device to:
determine the current portion based on receiving a request for supplemental content; and
determine the plurality of supplemental content assets by performing, using data associated with the current portion, a search for the plurality of supplemental content assets,
wherein:
the request for supplemental content represents a user-activation of a search function,
the search function is for supplemental content pertaining to what is depicted in the current portion, and
the user interface is configured to provide results of the search function.

13. The computing device of claim 1, the instructions, when executed, configure the computing device to:
determine a person depicted in the current portion; and
perform, based on the person, a search that results in at least one video depicting the person.

14. The computing device of claim 1, wherein the content item comprises an event for a sport that is between at least two entities, and wherein one or more of the plurality of supplemental content assets is associated with the sport or one of the at least two entities.

15. The computing device of claim 1, wherein the instructions, when executed, configure the computing device to determine the order of the plurality of supplemental content assets by ordering the plurality of supplemental content assets from highest to lowest importance as determined based on whether the content item was recorded by a digital video recorder and based on whether the content item was output for display at least once from the digital video recorder.

16. The computing device of claim 1, wherein the instructions, when executed, configure the computing device to determine the order of the plurality of supplemental content assets based on at least one of:
video-on-demand content that was output for display, or
linear content that was output for display.

17. One or more non-transitory computer-readable media storing instructions that, when executed, cause:
determining a current portion of a content item being output for display;
determining, by one or more computing devices and based on the current portion, a plurality of supplemental content assets;
determining, based on a viewing history of a user or content recorded by a digital video recorder, an order of the plurality of supplemental content assets; and
causing output of a user interface comprising a listing, based on the order, of the plurality of supplemental content assets.

18. The one or more non-transitory computer-readable media of claim 17, wherein the determining the current portion of content being output for display is performed based on receiving an indication of a user-activation of a supplemental content search function.

19. The one or more non-transitory computer-readable media of claim 17, wherein the determining the order of the plurality of supplemental content assets comprises performing a regression analysis based on whether the content item was recorded by the digital video recorder, whether a portion of the content item was output for display at least once from the digital video recorder, and whether second content was output for display during a broadcast of the second content.

20. The one or more non-transitory computer-readable media of claim 17, wherein:
the determining the order of the plurality of supplemental content assets comprises performing a regression analysis based on whether the content item was recorded by the digital video recorder, whether a portion of the content item was output for display at least once from the digital video recorder, and whether second content was output for display during a broadcast of the second content;
the performing the regression analysis comprises applying a first weight to first data indicating whether the content item was recorded by the digital video recorder, applying a second weight to second data indicating whether the portion of the content item was output for display at least once from the digital video recorder, and applying a third weight to third data indicating whether the second content was output for display during the broadcast of the second content; and
the instructions, when executed, cause adjusting the first weight or the second weight based on a survey taken by a user associated with the digital video recorder.

21. The one or more non-transitory computer-readable media of claim 17, wherein the determining the plurality of supplemental content assets comprises:
searching, based on the current portion, for the plurality of supplemental content assets; and
generating the listing of the plurality of supplemental content assets by determining, based on data indicating whether the content item was output for display at least once from the digital video recorder, that each of the plurality of supplemental content assets is to be included in the listing.

22. The one or more non-transitory computer-readable media of claim 17, wherein each of the plurality of supplemental content assets comprises a segment of a television program.

23. The one or more non-transitory computer-readable media of claim 17, wherein the determining the order of the plurality of supplemental content assets is based on one or more of: video analytics data of the current portion, or audio analytics data of the current portion.

24. The one or more non-transitory computer-readable media of claim 17, wherein the instructions, when executed, cause:
inserting, into a data stream that comprises the content, metadata associated with the current portion; and
determining, based on the metadata, data associated with the current portion, and wherein the determining the plurality of supplemental content assets is based on the data.

25. The one or more non-transitory computer-readable media of claim 17, wherein the determining the plurality of supplemental content assets is based on a request for supplemental content, and wherein the user interface indicates a response to the request for supplemental content.

26. The one or more non-transitory computer-readable media of claim 17, wherein the determining the current portion is based on receiving a request for supplemental content, and wherein the determining the plurality of supplemental content assets comprises performing, using data associated with the current portion, a search for the plurality of supplemental content assets.

27. The one or more non-transitory computer-readable media of claim 17, wherein the determining the current portion is based on receiving a request for supplemental content, and wherein the determining the plurality of supplemental content assets comprises performing, using data associated with the current portion, a search for the plurality of supplemental content assets via the World Wide Web.

28. The one or more non-transitory computer-readable media of claim 17, wherein:
the determining the current portion is based on receiving a request for supplemental content,
the determining the plurality of supplemental content assets comprises performing, using data associated with the current portion, a search for the plurality of supplemental content assets,
the request for supplemental content represents a user-activation of a search function, the search function is for supplemental content pertaining to what is depicted in the current portion, and
the user interface is configured to provide results of the search function.

29. The one or more non-transitory computer-readable media of claim 17, wherein the instructions, when executed, cause:
determining a person depicted in the current portion; and
performing, based on the person, a search that results in at least one video depicting the person.

30. The one or more non-transitory computer-readable media of claim 17, wherein the content item comprises an event for a sport that is between at least two entities, and wherein one or more of the plurality of supplemental content assets is associated with the sport or one of the at least two entities.

31. The one or more non-transitory computer-readable media of claim 17, wherein the determining the order of the plurality of supplemental content assets comprises ordering the plurality of supplemental content assets from highest to lowest importance as determined based on whether the content item was recorded by a digital video recorder and based on whether the content item was output for display at least once from the digital video recorder.

32. The one or more non-transitory computer-readable media of claim 17, wherein determining the order of the plurality of supplemental content assets is based on at least one of:
video-on-demand content that was output for display, or
linear content that was output for display.

33. A system comprising:
a first computing device; and
a second computing device;
wherein the first computing device comprises:
one or more first processors; and
memory storing first instructions that, when executed by the one or more first processors of the first computing device, configure the first computing device to:
determine a current portion of a content item being output for display;
determine, based on the current portion, a plurality of supplemental content assets;
determine, based on a viewing history of a user or content recorded by a digital video recorder, an order of the plurality of supplemental content assets; and
cause output of a user interface comprising a listing, based on the order, of the plurality of supplemental content assets;
wherein the second computing device comprises:
one or more second processors; and
memory storing second instructions that, when executed by the one or more second processors of the second computing device, configure the second computing device to:
output the user interface comprising the listing.

34. The system of claim 33, wherein the first instructions, when executed, configure the first computing device to determine, based on receiving an indication of a user-activation of a supplemental content search function, the current portion of the content item being output for display.

35. The system of claim 33, wherein the first instructions, when executed by the one or more first processors, configure the first computing device to determine the order of the plurality of supplemental content assets by performing a regression analysis based on whether the content item was recorded by the digital video recorder, whether a portion of the content item was output for display at least once from the digital video recorder, and whether second content was output for display during a broadcast of the second content.

36. The system of claim 33, wherein the first instructions, when executed by the one or more first processors, configure the first computing device to:
determine the order of the plurality of supplemental content assets by performing a regression analysis based on whether the content item was recorded by the digital video recorder, whether a portion of the content item was output for display at least once from the digital video recorder, and whether second content was output for display during a broadcast of the second content;
perform the regression analysis by applying a first weight to first data indicating whether the content item was recorded by the digital video recorder, applying a second weight to second data indicating whether the portion of the content item was output for display at least once from the digital video recorder, and applying a third weight to third data indicating whether the second content was output for display during the broadcast of the second content; and
adjust the first weight or the second weight based on a survey taken by a user associated with the digital video recorder.

37. The system of claim 33, wherein the first instructions, when executed by the one or more first processors, configure the first computing device to determine the plurality of supplemental content assets by:
searching, based on the current portion, for the plurality of supplemental content assets; and
generating the listing of the plurality of supplemental content assets by determining, based on data indicating whether the content item was output for display at least once from the digital video recorder, that each of the plurality of supplemental content assets is to be included in the listing.

38. The system of claim 33, wherein each of the plurality of supplemental content assets comprises a segment of a television program.

39. The system of claim 33, wherein the first instructions, when executed by the one or more first processors, configure the first computing device to determine the order of the plurality of supplemental content assets based on one or more of: video analytics data of the current portion, or audio analytics data of the current portion.

40. The system of claim 33, the first instructions, when executed by the one or more first processors, configure the first computing device to:
insert, into a data stream that comprises the content, metadata associated with the current portion; and
determine, based on the metadata, data associated with the current portion,
wherein the first instructions, when executed by the one or more first processors, configure the first computing device to determine the plurality of supplemental content assets based on the data.

41. The system of claim 33, wherein the first instructions, when executed by the one or more first processors, configure the first computing device to determine the plurality of supplemental content assets based on a request for supplemental content, and wherein the user interface indicates a response to the request for supplemental content.

42. The system of claim 33, wherein the first instructions, when executed by the one or more first processors, configure the first computing device to:
determine the current portion based on receiving a request for supplemental content; and
determine the plurality of supplemental content assets by:
performing, using data associated with the current portion, a search for the plurality of supplemental content assets.

43. The system of claim 33, wherein the first instructions, when executed by the one or more first processors, configure the first computing device to:
determine the current portion based on receiving a request for supplemental content; and
determine the plurality of supplemental content assets by:
performing, using data associated with the current portion, a search for the plurality of supplemental content assets via the World Wide Web.

44. The system of claim 33, wherein the first instructions, when executed by the one or more first processors, configure the first computing device to:
determine the current portion based on receiving a request for supplemental content, and
determine the plurality of supplemental content assets by performing, using data associated with the current portion, a search for the plurality of supplemental content assets,
wherein:
the request for supplemental content represents a user-activation of a search function,
the search function is for supplemental content pertaining to what is depicted in the current portion, and
the user interface is configured to provide results of the search function.

45. The system of claim 33, the first instructions, when executed by the one or more first processors, configure the first computing device to:
determine a person depicted in the current portion; and
perform, based on the person, a search that results in at least one video depicting the person.

46. The system of claim 33, wherein the content item comprises an event for a sport that is between at least two entities, and wherein one or more of the plurality of supplemental content assets is associated with the sport or one of the at least two entities.

47. The system of claim 33, wherein the first instructions, when executed by the one or more first processors, configure the first computing device to determine the order of the plurality of supplemental content assets by ordering the plurality of supplemental content assets from highest to lowest importance as determined based on whether the content item was recorded by a digital video recorder and based on whether the content item was output for display at least once from the digital video recorder.

48. The system of claim 33, wherein the first instructions, when executed by the one or more first processors, configure the first computing device to determine the order of the plurality of supplemental content assets based on at least one of:
video-on-demand content that was output for display, or
linear content that was output for display.
